(19) United States
(12) Patent Application Publication
(10) Pub. No.: US 2006/0223191 A1
(43) Pub. Date: Oct. 5, 2006

(54) Methods for measuring carbon single-walled nanotube content of carbon soot

(76) Inventors: Avetik Harutyunyan, Columbus, OH (US); Toshio Tokune, Columbus, OH (US)

Correspondence Address: HONDA/FENWICK, SILICON VALLEY CENTER, 801 CALIFORNIA STREET, MOUNTAIN VIEW, CA, 94041, US

(21) Appl. No.: 11/099,727

(22) Filed: Apr. 5, 2005

(51) Int. Cl. G01N 24/00

(52) U.S. Cl. 436/173

(57) ABSTRACT

Methods and processes for quantitating the carbon single-walled nanotubes (SWNTs) content in a sample are disclosed. The SWNTs soot can be produced by any of the known methods. The magic angle spinning (MAS) ¹³C NMR of a sample suspected of containing SWNTs and a standard at a known concentration are obtained, and the areas under the curve for the sample and the standard are calculated. Thereby, the concentration of ¹³C atoms involved in the formation of carbon SWNTs are calculated. Finally, by taking into account the natural distribution of ¹³C isotopes (about 1.1%), the total concentration of all carbon atoms responsible for the formation of SWNTs are calculated.

### FIELD OF INVENTION

The present invention relates to methods for the determining the components of carbon soot, particularly the use of nuclear magnetic resonance (NMR) spectroscopy to quantitatively determine the carbon single-walled nanotube (SWNT) content of a sample.

### background

Carbon nanotubes are hexagonal networks of carbon atoms forming seamless tubes with each end capped with half of a fullerene molecule. They were first reported in 1991 by Sumio Iijima who produced multi-layer concentric tubes or multi-walled carbon nanotubes by evaporating carbon in an arc discharge. In 1993, Iijima's group and an IBM team headed by Donald Bethune independently discovered that a single-wall nanotube could be made by vaporizing carbon together with a transition metal such as iron or cobalt in an arc generator (see Iijima et al. Nature 363:603 (1993); Bethune et al., Nature 363: 605 (1993) and U.S. Pat. No. 5,424,054). The original syntheses produced low yields of non-uniform nanotubes mixed with large amounts of soot and metal particles.

Presently, there are three main approaches for the synthesis of single- and multi-walled carbon nanotubes. These include the electric arc discharge of graphite rod (Journet et al. Nature 388:756 (1997)), the laser ablation of carbon (Thess et al. Science 273: 483 (1996)), and the chemical vapor deposition of hydrocarbons (Ivanov et al. Chem. Phys. Lett 223: 329 (1994); Li et al. Science 274: 1701 (1996)). Multi-walled carbon nanotubes can be produced on a commercial scale by catalytic hydrocarbon cracking while single-walled carbon nanotubes are still produced on a gram scale.

The known art methods for synthesizing carbon single-walled nanotubes (SWNTs) produce individual SWNTs and ropes of SWNTs commingled with impurities such as particles of metal catalyst and carbon material that is not in the form of SWNTs, sometimes referred to as soot or amorphous carbon. In order to investigate the structural, mechanical, and electronic properties of SWNTs, the impurities must be removed. In one method, the impurities can be removed by treatment with an acid, such as HNO₃, H₂SO₄, HCl, HF, HI, or HBr (U.S. Pat. No. 6,752,977). The purified SWNTs can then be characterized by X-ray diffraction (XRD), scanning tunneling microscopy (STS), transmission electron microscopy (TEM), Raman spectroscopy, temperature programmed oxidation (TPO) and the like.

Electron microscopy (TEM/SEM) and thermal gravimetric analysis (TGA) have been used to obtain qualitative information on the various carbon species present in a sample. The use of ¹³C nuclear magnetic resonance (NMR) and programmed oxidation (TPO) to quantify the amount of SWNT present in a sample has been proposed. In NMR, for example, the metallic SWNTs show fast spin-lattice relaxation rates, whereas the non-metallic SWNTs exhibit slow-relaxing components, and significantly lower density-of-states at the Fermi level (Tang et al. (2000) Science 288: 492-494). However, in order to study SWNTs using ¹³C NMR, ¹³C enriched (typically 10 wt %) SWNTs must be produced. Producing ¹³C enriched SWNTs can be expensive. Therefore, there is a need for simple and reliable methods for NMR investigation of SWNTs properties. Accordingly, the present invention provides methods and processes for NMR investigation of SWNTs without ¹³C enrichment.

The quantitative determination of carbon SWNTs in carbon soot can be performed using TPO, TEM, Raman, and near IR spectroscopy (Herrea and Resasco (2003) Chem. Phy. Lett. 376: 302-309). The most widely used method is TPO (U.S. Pat. No. 6,333,016). TPO experiments conducted by the Resasco group (W. E. Alvarez et al. (2002) Chemistry of Materials 14:1853-1858) employ a continuous flow of 5% O₂/He passing over the catalyst containing the carbon deposits while the temperature is linearly increased (11° C./min). The evolution of CO₂ produced by the oxidation of the carbon species is monitored by a mass spectrometer. Quantification of the evolved CO₂ is calibrated with 100 μl pulses of pure CO₂ and is considered to provide a measurement of the amount of carbon oxidized at each temperature. This technique provides an apposite calibration for quantitative characterization of SWNT. Further, TPO can reliably be applied to only catalysts prepared on similar supports and under similar preparation techniques and used under similar operating conditions. Further, the technique is destructive. Therefore, there is a need for a non-destructive method for quantitative determination of carbon SWNTs in soot.

### SUMMARY

The present invention provides methods and processes for quantifying single-walled carbon nanotubes (SWNTs).

In one aspect, method for determining the concentration of single-walled carbon nanotubes (SWNTs) in a sample is provided. The method comprises obtaining ¹³C NMR of a sample comprising SWNTs and a known concentration of a standard, calculating the area under the curve for the ¹³C NMR signal for SWNTS and the ¹³C NMR signal for the standard, and determining the concentration of SWNTs by comparing the area under the curve for the sample signal and the standard signal.

These and other aspects of the present invention will become evident upon reference to the following detailed description. In addition, various references are set forth herein which describe in more detail certain procedures or compositions, and are therefore incorporated by reference in their entirety.

### BRIEF DESCRIPTION OF DRAWINGS

FIG. 1 illustrates a magic angle spinning (MAS) ¹³C nuclear magnetic resonance (NMR) of a sample containing SWNTs using 1,1-diphenyl-2-picrylhydrazyl as a standard.

### DETAILED DESCRIPTION

I. Definitions

Unless otherwise stated, the following terms used in this application, including the specification and claims, have the definitions given below. It must be noted that, as used in the specification and the appended claims, the singular forms “a,” “an” and “the” include plural referents unless the context clearly dictates otherwise. Definition of standard chemistry terms may be found in reference works, including Carey and Sundberg (1992) “Advanced Organic Chemistry 3^{rd} Ed.” Vols. A and B, Plenum Press, New York, and Cotton et al. (1999) “Advanced Inorganic Chemistry 6^{th} Ed.” Wiley, New York.

The terms “single-walled carbon nanotube” or “one-dimensional carbon nanotube” are used interchangeable and refer to cylindrically shaped thin sheet of carbon atoms having a wall consisting essentially of a single layer of carbon atoms, and arranged in an hexagonal crystalline structure with a graphitic type of bonding.

The term “multi-walled carbon nanotube” as used herein refers to a nanotube composed of more than one concentric tubes.

The terms “metalorganic” or “organometallic” are used interchangeably and refer to coordination compounds of organic compounds and a metal, a transition metal or metal halide.

II. Overview

The present invention discloses methods and processes for characterizing single-walled carbon nanotubes (SWNTs) and for quantitative measurements of SWNTs in a sample. The SWNTs can be produced by any of the known methods. The sample suspected of containing SWNTs can be studied by solid state NMR, such as magic angle spinning (MAS) ¹³C NMR. The NMR spectra thus obtained can be compared with the NMR spectra of a standard such as 1,1-diphenyl-2-picrylhydrazyl (DPPH). The quantity of SWNTs in the sample can be determined by comparing the areas under the curve for the sample with the standard, or by comparing the signal intensities in the MAS ¹³C NMR.

III. Synthesis of Carbon Nanotubes

The SWNTs can be fabricated according to a number of different techniques familiar to those in the art. For example, the SWNTs can be fabricated by the laser ablation method of U.S. Pat. No. 6,280,697, the arc discharge method of Journet et al. Nature 388: 756 (1997), the chemical vapor deposition method where supported metal nanoparticles can be contacted with the carbon source at the reaction temperatures according to the literature methods described in Harutyunyan et al., NanoLetters 2, 525 (2002), and the like. Preferably, the SWNTs are produced by the chemical vapor deposition method.

The chemical vapor deposition (CVD) method for the synthesis of carbon nanotubes uses carbon precursors, such as carbon containing gases. In general, any carbon containing gas that does not pyrolize at temperatures up to 800° C. to 1000° C. can be used. Examples of suitable carbon-containing gases include carbon monoxide, aliphatic hydrocarbons, both saturated and unsaturated, such as methane, ethane, propane, butane, pentane, hexane, ethylene, acetylene and propylene; oxygenated hydrocarbons such as acetone, and methanol; aromatic hydrocarbons such as benzene, toluene, and naphthalene; and mixtures of the above, for example carbon monoxide and methane. In general, the use of acetylene promotes formation of multi-walled carbon nanotubes, while CO and methane are preferred feed gases for formation of single-walled carbon nanotubes. The carbon-containing gas may optionally be mixed with a diluent gas such as hydrogen, helium, argon, neon, krypton and xenon or a mixture thereof.

The catalyst composition for use in CVD can be any catalyst composition known to those of skill in the art. Conveniently, the particles will be of a magnetic metal or alloy, such as, for example, iron, iron oxide, or a ferrite such as cobalt, nickel, chromium, yttrium, hafnium or manganese. The particles useful according to the invention will preferably have an average overall particle size from about 50 nm to about 1 μm, although, in general, the particle sizes for individual particles can be from about 400 nm to about 1 μm.

The function of the catalyst when used in the carbon nanotube growth process is to decompose the carbon precursors and aid the deposition of ordered carbon. The methods and processes of the present invention preferably use metal nanoparticles as the metallic catalyst. The metal or combination of metals selected as the catalyst can be processed to obtain the desired particle size and diameter distribution, and can be separated by being supported on a material suitable for use as a support during synthesis of carbon nanotubes. As known in the art, the support can be used to separate the catalyst particles from each other thereby providing the catalyst materials with greater surface area in the catalyst composition. Such support materials include powders of crystalline silicon, polysilicon, silicon nitride, tungsten, magnesium, aluminum and their oxides, preferably aluminum oxide, silicon oxide, magnesium oxide, or titanium dioxide, or combination thereof, optionally modified by addition elements, are used as support powders. Silica, alumina and other materials known in the art may be used as support; preferably alumina is used as the support.

The metal catalyst can be selected from a Group V metal, such as V or Nb, and mixtures thereof, a Group VI metal including Cr, W, or Mo, and mixtures thereof, a Group VII metal, such as, Mn, or Re, a Group VIII metal including Co, Ni, Ru, Rh, Pd, Os, Ir, Pt, and mixtures thereof, or a lanthanide, such as Ce, Eu, Er, or Yb and mixtures thereof, or a transition metal such as Cu, Ag, Au, Zn, Cd, Sc, Y, or La and mixtures thereof. Specific examples of mixture of catalysts, such as bimetallic catalysts, which may be employed by the present invention include Co—Cr, Co—W, Co—Mo, Ni—Cr, Ni—W, Ni—Mo, Ru—Cr, Ru—W, Ru—Mo, Rh—Cr, Rh—W, Rh—Mo, Pd—Cr, Pd—W, Pd—Mo, Ir—Cr, Pt—Cr, Pt—W, and Pt—Mo. Preferably, the metal catalyst is iron, cobalt, nickel, molybdenum, or a mixture thereof, such as Fe—Mo, Co—Mo and Ni—Fe—Mo.

The metal, bimetal, or combination of metals are used to prepare metal nanoparticles having defined particle size and diameter distribution. The catalyst nanoparticles can be prepared by thermal decomposition of the corresponding metal salt added to a passivating solvent, and the temperature of the solvent adjusted to provide the metal nanoparticles, as described in the co-pending and co-owned U.S. patent application Ser. No. 10/304,316, or by any other method known in the art. The particle size and diameter of the metal nanoparticles can be controlled by using the appropriate concentration of metal in the passivating solvent and by controlling the length of time the reaction is allowed to proceed at the thermal decomposition temperature. The metal salt can be any salt of the metal, and can be selected such that the salt is soluble in the solvent and/or the melting point of the metal salt is lower than the boiling point of the passivating solvent. Thus, the metal salt contains the metal ion and a counter ion, where the counter ion can be nitrate, nitrite, nitride, perchlorate, sulfate, sulfide, acetate, halide, oxide, such as methoxide or ethoxide, acetylacetonate, and the like. For example, the metal salt can be iron acetate (FeAc₂), nickel acetate (NiAc₂), palladium acetate (PdAc₂), molybdenum acetate (MoAc₃), and the like, and combinations thereof The melting point of the metal salt is preferably about 5° C. to 50° C. lower than the boiling point, more preferably about 5° C. to about 20° C. lower than the boiling point of the passivating solvent. The solvent can be an ether, such as a glycol ether, 2-(2-butoxyethoxy)ethanol, H(OCH₂CH₂)₂O(CH₂)₃CH₃, which will be referred to below using the common name dietheylene glycol mono-n-butyl ether, and the like.

Preferably, the support material is added to the reaction mixture containing the metal salt. The support material can be added as a solid, or it can be first dissolved in the passivating solvent and then added to the solution containing the metal salt. The solid support can be silica, alumina, MCM-41, MgO, ZrO₂, aluminum-stabilized magnesium oxide, zeolites, or other supports known in the art, and combinations thereof. For example, Al₂O₃—SiO₂ hybrid support could be used. Preferably, the support material is soluble in the passivating solvent. In one aspect, the counterion of the metal salt and the support material is the same, thus, for example, nitrites can be the counterion in the metal salt and in the support material. Thus, the support material contains the element of the support material and a counter ion, where the counter ion can be nitrate, nitrite, nitride, perchlorate, sulfate, sulfide, acetate, halide, oxide, such as methoxide or ethoxide, acetylacetonate, and the like. Thus, for example, nitrites can be the counterion in metal ions (ferrous nitrite) and in the support material (aluminum nitrite), or the support can be aluminum oxide (Al₂O₃) or silica (SiO₂). The support material can be powdered thereby providing small particle sizes and large surface areas. The powdered support material can preferably have a particle size between about 0.01 μm to about 100 μm, more preferably about 0.1 μm to about 10 μm, even more preferably about 0.5 μm to about 5 μm, and most preferably about 1 μm to about 2 μm. The powdered support material can have a surface area of about 50 to about 1000 m²/g, more preferably a surface area of about 200 to about 800 m²/g. The powdered oxide can be freshly prepared or commercially available. For example, a suitable Al₂O₃ powder with 1-2 μm particle size and having a surface area of 300-500 m²/g is commercially available from Alfa Aesar of Ward Hill, Mass., or Degussa, N.J. Powdered oxide can be added to achieve a desired weight ratio between the powdered oxide and the initial amount of metal used to form the metal nanoparticles. Typically, the weight ratio can be between about 10:1 and about 15:1. For example, if 100 mg of iron acetate is used as the starting material, then about 320 to 480 mg of powdered oxide can be introduced into the solution. The weight ratio of metal nanoparticles to powdered oxide can be between about 1:1 and 1:10, such as, for example, 1:1, 2:3, 1:4, 3:4, 1:5, and the like.

After forming a homogenous mixture, metal nanoparticles are formed during the thermal decomposition. The thermal decomposition reaction is started by heating the contents of the reaction vessel to a temperature above the melting point of at least one metal salt in the reaction vessel. The average particle size of the metal nanoparticles can be controlled by adjusting the length of the thermal decomposition. Typical reaction times range from about 20 minutes to about 2400 minutes, depending on the desired nanoparticle size. Metal nanoparticles having an average particle size of about 0.01 nm to about 20 nm, more preferably about 0.1 nm to about 3 nm and most preferably about 0.3 nm to 2 nm can be prepared. The metal nanoparticles can thus have a particle size of 0.1, 1, 2, 3, 4, 5, 6, 7, 8, 9, or 10 nm, and up to about 20 nm. In another aspect, the metal nanoparticles can have a range of particle size, or diameter distribution. For example, the metal nanoparticles can have particle sizes in the range of about 0.1 nm and about 5 nm in size, about 3 nm and about 7 nm in size, or about 5 nm and about 11 nm in size.

The supported metal nanoparticles can be aerosolized by any of the art known methods. In one method, the supported metal nanoparticles are aerosolized using an inert gas, such as helium, neon, argon, krypton, xenon, or radon. Preferably argon is used. Typically, argon, or any other gas, is forced through a particle injector, and into the reactor. The particle injector can be any vessel that is capable of containing the supported metal nanoparticles and that has a means of agitating the supported metal nanoparticles. Thus, the catalyst deposited on a powdered porous oxide substrate can be placed in a beaker that has a mechanical stirrer attached to it. The supported metal nanoparticles can be stirred or mixed in order to assist the entrainment of the catalyst in the transporter gas, such as argon.

Thus, the nanotube synthesis generally occurs as described in the co-pending and co-owned application U.S. Ser. No. 10/727,707, filed on Dec. 3, 2003. An inert transporter gas, preferably argon gas, is generally passed through a particle injector. The particle injector can be a beaker or other vessel containing the growth catalyst supported on a powdered porous oxide substrate. The powdered porous oxide substrate in the particle injector can be stirred or mixed in order to assist the entrainment of the powdered porous oxide substrate in the argon gas flow. Optionally, the inert gas can be passed through a drying system to dry the gas. The argon gas, with the entrained powdered porous oxide, can then be passed through a pre-heater to raise the temperature of this gas flow to about 400° C. to about 500° C. The entrained powdered porous oxide is then delivered to the reaction chamber. A flow of methane or another carbon source gas and hydrogen is also delivered to the reaction chamber. The typical flow rates can be 500 sccm for argon, 400 sccm for methane, and 100 sccm for He. Additionally, 500 sccm of argon can be directed into the helical flow inlets to reduce deposition of carbon products on the wall of the reaction chamber. The reaction chamber can be heated to between about 300° C. and 900° C. during reaction using heaters. The temperature is preferably kept below the decomposition temperature of the carbon precursor gas. For example, at temperatures above 1000° C., methane is known to break down directly into soot rather than forming carbon nanostructures with the metal growth catalyst. Carbon nanotubes and other carbon nanostructures synthesized in reaction chamber can then be collected and characterized.

The carbon nanotubes and nanostructures produced by the methods and processes described above can be used in applications that include Field Emission Devices, Memory devices (high-density memory arrays, memory logic switching arrays), Nano-MEMs, AFM imaging probes, distributed diagnostics sensors, and strain sensors. Other key applications include: thermal control materials, super strength and light weight reinforcement and nanocomposites, EMI shielding materials, catalytic support, gas storage materials, high surface area electrodes, and light weight conductor cable and wires, and the like.

In one aspect of the invention, the diameter distribution of the synthesized SWNTs is substantially uniform. Thus, about 90% of the SWNTs have a diameter within about 25% of the mean diameter, more preferably, within about 20% of the mean diameter, and even more preferably, within about 15% of the mean diameter. Thus, the diameter distribution of the synthesized SWNTs can be about 10% to about 25% within the mean diameter, more preferably about 10% to about 20% of the mean diameter, and even more preferably about 10% to about 15% of the mean diameter.

In another aspect, the prepared carbon nanotube sample can contain additional materials formed during synthesis of the carbon nanotubes, such as amorphous carbon created as a reaction byproduct during synthesis of carbon nanotubes by CVD or laser vaporization. Further, the SWNTs can contain materials added to facilitate carbon nanotube synthesis, such as metal nanoparticles used as a growth catalyst. In still another embodiment, the prepared carbon nanotube sample may contain low levels of additional materials, such as trace levels of metals or other impurities.

In another aspect, the SWNTs can be optionally further treated to remove additional conductive or ferromagnetic materials. For example, SWNTs synthesized by CVD growth on a growth catalyst composed of metal nanoparticles can optionally be treated with an acid to remove the metal nanoparticles. The treatment removes the conductive or ferromagnetic materials that are present in sufficient amount to interact with the magnetic fields used for NMR analysis and/or result in line broadening of the spectra.

Alternatively, single-wall carbon nanotubes can be made in a DC arc discharge apparatus by simultaneously evaporating carbon and a small percentage of Group VIIIb transition metal from the anode of the arc discharge apparatus. The products obtained from this method normally provide only a low yield of carbon nanotubes, and the population of carbon nanotubes can exhibit significant variations in structure and size. In another method of producing single-wall carbon nanotubes, laser vaporization of a graphite substrate doped with transition metal atoms, such as nickel, cobalt, or a mixture thereof. The single-wall carbon nanotubes produced by this method tend to be formed in clusters or ropes of about 10 to about 1000 single-wall carbon nanotubes in parallel alignment held by van der Waals forces in a closely packed triangular lattice. Recently, a method for producing single-wall carbon nanotubes has been reported that uses high pressure CO as the carbon feedstock and a gaseous transition metal catalyst precursor as the catalyst (WO 00/26138, published May 11, 2000). The method can be carried out continuously, and it produces single-wall carbon nanotubes without simultaneously making multi-wall nanotubes. Furthermore, the method produces single-wall carbon nanotubes in relatively high purity, such that less than about 10 wt % of the carbon in the solid product is attributable to other carbon-containing species, which includes both graphitic and amorphous carbon. The sample containing SWNTs can be made by any one of the known methods, or may be obtained from other sources, such as from commercial sources or from research laboratories.

IV. Measuring the Carbon Nanotube Content

The SWNTs synthesized above can be characterized by solid-state nuclear magnetic resonance (NMR) techniques. The SWNTs can be present in a sample containing impurities such as amorphous carbon, or the SWNTs can be purified using one of the art methods prior to NMR studies. NMR is based on the interaction of electromagnetic waves with an NMR active nuclei under an applied, external magnetic field. NMR active nuclei have an odd atomic mass or an odd atomic number and therefore possess a nuclear magnetic moment. The magnetic properties of a nucleus are conveniently discussed in terms of two quantities: the gyromagnetic ratio (γ), and the nuclear spin (I). When an NMR active nucleus is placed in a magnetic field, its nuclear magnetic energy levels are split into (2I+1) non-degenerate energy levels, which are separated from each other by an energy difference that is directly proportional to the strength of the applied magnetic field. This splitting is called the “Zeeman” splitting, and the frequency corresponding to the energy of the Zeeman splitting is called the “Larmor frequency” that is proportional to the field strength of the magnetic field. Typical NMR active nuclei include ¹H (protons), ¹³C, ¹⁹F, and ³¹P. For these four nuclei I=½, and each nucleus has two nuclear magnetic energy levels. When the energy difference between splitted levels becomes the same as an applied radiofrequency quant, resonance absorption occurs.

When a bulk sample containing NMR active nuclei is placed within a magnetic field, the nuclear spins distribute themselves amongst the nuclear magnetic energy levels in accordance with Boltzmann's statistics. This results in a population imbalance between the energy levels and a net nuclear magnetization that is studied by NMR techniques.

At equilibrium, the net nuclear magnetization is aligned parallel to the external magnetic field and is static. A second magnetic field (“radio frequency” or RF field) perpendicular to the first and rotating at, or near, the Larmor frequency can be applied to induce a coherent motion of the net nuclear magnetization.

In addition to precessing at the Larmor frequency, in the absence of the applied RF energy, the nuclear magnetization also undergoes two relaxation processes: (1) the precessions of various individual nuclear spins which generate the net nuclear magnetization become dephased with respect to each other so that the magnetization within the transverse plane loses phase coherence (“spin-spin relaxation”) with an associated relaxation time, T₂, and (2) the individual nuclear spins return to their equilibrium population of the nuclear magnetic energy levels (“spin-lattice relaxation”) with an associated relaxation time, T₁.

Samples of solids or gels typically display broad NMR resonances when measured via liquid state NMR methods since the molecules are not free to tumble rapidly and isotropically. These additional broadenings arise from dipole-dipole interactions between spins, the anisotropy of the chemical shift and local variations in the magnetic susceptibility. Magic angle sample spinning (MAS) is a means of restoring the spectra to a high resolution result by introducing a physical rotation of the sample as a whole about the magic angle (θₘ) to the static field direction, where cos θₘ=(⅓)^{1/2}. This angle corresponds to the bisector of a cube, and rotation about this axis creates an equal weighting of evolution for the x, y, and z directions, averaging out the local variations. Provided that the spinning rate is fast compared to the line width, sharp resonances are observed in MAS experiments. Spinning rates of from 2 to 20 kHz are routinely achieved in MAS probes.

Typically, the sample to be characterized by solid state NMR can be placed in a spinner, such as a 7 mm ZrO spinner. The ¹³C NMR spectra can be collected using magic angle spinning at 200 K to about 400 K, preferably at about 280 K to about 315 K, or more preferably at about room temperature. The sample can be spun at about 2 kHz to about 20 kHz, preferably about 5 kHz to about 15 kHz, more preferably about 8 kHz to about 15 kHz, or any frequency in between, such as, for example, 9 kHz, 10 kHz, 11 kHz, 12 kHz, 13 kHz, 14 kHz, and the like. A number of scans can be obtained, such as for example 2 scans to about 1000 scans, or any number in between. Alternatively, a single scan can be obtained.

In one aspect of the invention, a standard compound having a known concentration can be added to the sample prior to NMR studies. The standard is selected such the signal from the standard does not interfere with the signal from the SWNTs present in the sample. Thus, the standard is preferably an aromatic or has carbon atoms with shifts closer to those expected for SWNTs, and can be a solid or a liquid but is preferably a solid. The standard preferably is a solid, such as 1,1-diphenyl-2-picrylhydrazyl (DPPH), or acetophenone, or it can be liquid, such as trimethylsilane (TMS). In another aspect, the MAS ¹³C NMR of the sample and the standard can be obtained separately. In yet another aspect, the MAS ¹³C NMR of the standard at different concentrations can be obtained, a plot of the concentration against the area under the curve for the ¹³C signal can be created, and the MAS ¹³C NMR of sample obtained separately.

The SWNTs in the sample can be quantitated by calculating the area under the curve for the ¹³C signal for the SWNTs in the sample and for the standard. Since the number of carbon atoms in each molecule of the standard and the total concentration are known, the ratio of the area under the curve for the sample and the standard can be used to quantitate the SWNTs in the sample. For example, the SWNT in a sample can be quantitated using the equation:
N^{C}_{SWNT}=N^{C}_{standard} I_{SWNT}/I_{standard}
where N^{C}_{SWNT} is the concentration of ¹³C isotopes contributed in carbon by SWNTs, N^{C}_{standard} is the concentration of ¹³C isotopes in the standard sample, I_{SWNT} is the NMR signal intensity of carbon in the SWNTs, and I_{standard} is the NMR signal intensity of standard sample. Alternatively, a graph can be created where the concentration of the standard can be plotted against the area under the curve for the ¹³C signal at that concentration, the area under the curve for the ¹³C signal from the SWNTs in the sample can be calculated, and the concentration of SWNTs in the sample can be estimated from the graph. Finally, taking into account that the natural distribution of ¹³C isotope is approximately 1.1%, the total number of C atoms involved in the formation of nanotubes can be quantitatively calculated.

### EXAMPLES

Below are examples of specific embodiments for carrying out the present invention. The examples are offered for illustrative purposes only, and are not intended to limit the scope of the present invention in any way. Efforts have been made to ensure accuracy with respect to numbers used (e.g., amounts, temperatures, etc.), but some experimental error and deviation should, of course, be allowed for.

### Example 1

### Preparation of the Supported Catalyst

Catalysts were prepared by impregnating support materials in metal salt solutions. In a typical procedure, Fe(NO₂)₂ was used at a molar ratio of Fe:Al of 1:2. Under a nitrogen atmosphere, Fe(NO₂)₂ was added to water in the molar ratio of 1 mM:20 mM. Then aluminum nitrite was added to the metal salt containing aqueous solution. The reaction mixture was mixed using a mechanical stirrer under the nitrogen atmosphere, and heated under reflux for 90 minutes. The reaction was cooled to about 60° C. while flowing a stream of N₂ over the mixture to remove the solvent. A rose film formed on the walls of the reaction flask. The black film was collected and ground with an agate mortar to obtain a fine black powder.

### Example 2

### Synthesis of Carbon Nanotubes

Carbon nanotubes were synthesized by using the experimental setup described in Harutyunyan et al., NanoLetters 2, 525 (2002). CVD growth of bulk SWNTs used the catalysts prepared in Example 1 and methane as a carbon source (T=800° C., methane gas flow rate 60 sccm). The carbon SWNTs were successfully synthesized with a yield of about 40 wt % (wt % carbon relative to the iron/alumina catalyst). The carbon nanotubes were analyzed using transmission electron microscopy (TEM) and Raman spectra using λ=532 nm and λ=785 nm laser excitation.

The carbon nanotubes were purified from metal residue and from the solid support by acid treatment. The aluminum oxide support was removed by washing with HF. The product from the synthesis step was placed in concentrated HF, sonicated for 6 h, and then left to stand overnight. The solid was collected by filtration through a 0.05 μm filter, washed with hot distilled water at approximate pH 7, and dried at 110° C. for 6 h. Amorphous carbon was removed by selective oxidation. Approximately 220 mg of the sample was placed in a chamber. The temperature was increased at a rate of 10° C./min until temperature of 400° C. was achieved. The sample was maintained at the temperature for 20 min under an airflow of 100 sccm. The Fe/Mo catalyst was removed by washing with hydrochloric acid. The sample was placed in concentrated HCl, and sonicated for 6 h. The solid was collected by filtration through a 0.05 μm filter, washed with hot distilled water at approximate pH 7, and dried at 110° C. for 6 h. Amorphous carbon was removed by a second selective oxidation. Approximately 95 mg of the sample was placed in a chamber. The temperature was increased at a rate of 10° C./min until temperature of 430° C. was achieved. The sample was maintained at the temperature for 20 min under an airflow of 100 sccm. The sample thus obtained was washed a second time with HCl to remove Fe/Mo catalyst particles. The sample was placed in concentrated HCl, and sonicated for 6 h. The solid was collected by filtration through a 0.05 μm filter, washed with hot distilled water at approximate pH 7, and dried at 110° C. for 6 h. The SWNTs thus obtained had less than about 1% wt/wt of the metal residue.

### Example 3

### MAS ¹³C NMR

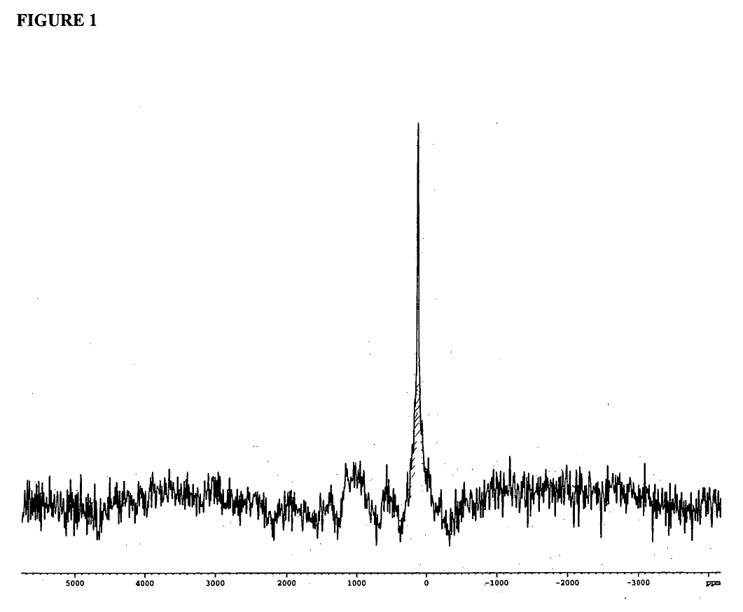

Carbon nanotubes synthesized in Example 2 (50 mg), were placed in inside a quartz tube and placed in the resonator of the ASX400 Bruker spectrometer operating at 9.4T magnetic filed, H¹ frequency 400 MHz, C¹³ frequency of 100 MHz at room temperature. The sample was spun at 5 kHz to 15 kHz. The parameters for obtaining the spectra were recycle delay between experiments of 5 s, length of 90 degree pulse of 4 microseconds, and dwell time of sampling of 0.5 microseconds. 1024 points were obtained, and a total of 200 scans were obtained resulting in approximately 20 minute acquisition times. The resulting ¹³C NMR MAS spectrum for the sample containing SWNT is shown in FIG. 1. The major resonance peaks for the solid state carbon spectrum of DPPH are upfield from 100 ppm.

While the invention has been particularly shown and described with reference to a preferred embodiment and various alternate embodiments, it will be understood by persons skilled in the relevant art that various changes in form and details can be made therein without departing from the spirit and scope of the invention. All printed patents and publications referred to in this application are hereby incorporated herein in their entirety by this reference.

We claim:

1. A method for determining the concentration of single-walled carbon nanotubes (SWNTs) in a sample, the method comprising:
obtaining ¹³C NMR of a sample comprising SWNTs and a known concentration of a standard;
calculating the area under the curve for the ¹³C NMR signal for SWNTS and the ¹³C NMR signal for the standard; and
determining the concentration of SWNTs by comparing the area under the curve for the sample signal and the standard signal.

2. The method of claim 1, wherein the SWNTs are not ¹³C enriched.

3. The method of claim 1, wherein the sample further comprises soot or amorphous carbon.

4. The method of claim 1, wherein the standard is a solid.

5. The method of claim 4, wherein the standard is 1,1-diphenyl-2-picrylhydrazyl.

6. The method of claim 1, wherein the standard is a liquid.

7. The method of claim 6, wherein the standard is TMS.

8. The method of claim 1, wherein the ¹³C NMR comprises magic angle spinning (MAS) ¹³C NMR.
